(19) United States
(12) Patent Application Publication
(10) Pub. No.: US 2020/0004389 A1
(43) Pub. Date: Jan. 2, 2020

(54) HIERARCHY EDITOR TOOL FOR SOURCE CODE

(71) Applicant: CERNER INNOVATION, INC., Kansas City, KS (US)

(72) Inventors: ISAAC PACHT, Flushing, NY (US); JOAN KUCEWICZ, Phoenixville, PA (US); JOHN SOETY, Media, PA (US)

(21) Appl. No.: 16/025,675

(22) Filed: Jul. 2, 2018

(51) Int. Cl. G06F 3/0482; G06F 3/0484; G06F 17/24; G06F 17/22

(52) U.S. Cl. CPC G06F 3/0482; G06F 17/2247; G06F 17/241; G06F 3/0484

(57) ABSTRACT

Embodiments herein disclose a hierarchy editor tool. In embodiments, the editor generates hierarchy trees of nested nodes that represent source code of each of a baseline user interface, a custom user interface, and a new user interface. The editor also generates a hybrid or intermediate hierarchy tree that is a combination of the custom tree and the new tree. The editor identifies when nodes in the intermediate tree are in conflict, based on changes between the custom tree and the new tree relative to the baseline tree. The editor provides options to resolve said node conflicts and a GUI provides a dynamically updated visualization of the intermediate tree based on option selections. Once all conflicts are resolved and a validation check is performed, the editor finalizes the intermediate tree and writes source code for a user interface that reflects the finalized intermediate tree, in embodiments.

### BACKGROUND

User interfaces are supported by executing computer source code. Editing user interfaces requires directly manipulating the source code itself. Editing source code often produces logical errors and structural inconsistencies which cause the user interface to fail.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims as supported by the Specification, including the Detailed Description and Drawings.

In brief and at a high level, this disclosure describes, among other things, methods, systems, and computer-readable media for creating hierarchies of nested nodes from source code, editing hierarchies of the nested nodes that represent source code, resolving node conflicts between various hierarchies, and performing validation checks to create a new finalized object from a custom-built hierarchy.

A computerized method is provided in an embodiment of the present invention. The method comprises obtaining code for each of a baseline user interface, a custom user interface, and a new user interface. The method further comprises generating a baseline tree, a custom tree, and a new tree based on a plurality of unique identifiers located in the respective code of the baseline user interface, the custom user interface, and the new user interface. In embodiments, each of the baseline tree, the custom tree, and the new tree include a hierarchy of nested nodes that represent respective structures of the baseline user interface, the custom user interface, or the new user interface. The method comprises, in embodiments, generating an intermediate tree that is a combination of the custom tree and the new tree. In an embodiment, the intermediate tree includes a hierarchy of nested nodes that represent the structures of one or more of the custom user interface or the new user interface. The method further comprises identifying a conflict between at least one of the nested nodes in the baseline tree relative to at least one of the nested nodes in the intermediate tree. In accordance with the method, the method concurrently presents a user-interactive visual representation of the baseline tree and the intermediate tree via a graphical user interface (GUI). In the GUI presented via the method, the one or more nested nodes in the intermediate tree is annotated with a conflict resolution icon to represent the conflict identified. The method further comprises dynamically updating the intermediate tree in the GUI in response to a user interaction with the GUI designating a resolution to the one or more conflicts. In response to an indication to finalize the intermediate tree, the method comprises encoding the hierarchy of nested nodes of the intermediate tree to create a finalized user interface that is a merger of the structures of one or more of the custom user interface and the new user interface.

Another embodiment provides one or more non-transitory computer-readable media having computer-executable instructions embodied thereon that, when executed, perform a method. The method comprises obtaining code for each of a baseline user interface, a custom user interface, and a new user interface. For each of the baseline user interface, the custom user interface, and the new user interface, the method comprises locating a plurality of unique identifiers in the code that correspond to structures of one or more of the baseline user interface, the custom user interface, and the new user interface. In an embodiment, the method comprises generating a baseline tree that represents the baseline user interface based on the plurality of unique identifiers located in the code of the baseline user interface. The baseline tree includes a hierarchy of nested nodes that represent the structures of the baseline user interface. The method further comprises generating a custom tree that represents the custom user interface based on the plurality of unique identifiers located in the code of the custom user interface. The custom tree includes a hierarchy of nested nodes that represent the structures of the custom user interface, in an embodiment. The method also comprises generating a new tree that represents the new user interface based on the plurality of unique identifiers located in the code of the new user interface. In an embodiment, the new tree includes a hierarchy of nested nodes that represent the structures of the new user interface. In accordance with the media, the method further comprises identifying differences between the nested nodes of the baseline tree and the custom tree, and between the nested nodes of the baseline tree and the new tree. The method comprises, in embodiments, generating an intermediate tree that is a combination of the custom tree and the new tree. In an embodiment, the intermediate tree includes a hierarchy of nested nodes that represent the structures of one or more of the custom user interface or the new user interface.

The method identifies a conflict in the intermediate tree. In embodiments, the method concurrently presents a user-interactive visual representation of the baseline tree and the intermediate tree via a graphical user interface (GUI). In an embodiment, one or more nested nodes in the intermediate tree is annotated with a conflict resolution icon to represent the conflict identified. In accordance with the media, the method comprises dynamically updating the intermediate tree in the GUI in response to a user interaction with the GUI designating a resolution to the one or more conflicts. In response to an indication to finalize the intermediate tree, the method further comprises encoding the hierarchy of nested nodes of the intermediate tree to create a finalized user interface that is a merger of the structures of one or more of the custom user interface and the new user interface.

Yet another embodiment provides one or more non-transitory computer-readable media having computer-executable instructions embodied thereon that, when executed, perform a method. In accordance with the media, the method performed comprises obtaining code for each of a baseline user interface, a custom user interface, and a new user interface. For each of the baseline user interface, the custom user interface, and the new user interface, the method locates a plurality of unique identifiers in the code that corresponds to structures of one or more of the baseline user interface, the custom user interface, and the new user interface. In embodiments, the method comprises generating a baseline tree, a custom tree, and a new tree based on the plurality of unique identifiers located in the respective code of the baseline user interface, the custom user interface, and the new user interface. Each of the baseline tree, the custom tree, and the new tree include a hierarchy of nested nodes that represent the structures of the respective baseline user interface, custom user interface, or new user interface, in embodiments. The method further comprises generating an intermediate tree that is a combination of the custom tree and the new tree based on the plurality of unique identifiers located in the code of the custom user interface and the plurality of unique identifiers located in the code of the new user interface. The intermediate tree includes a hierarchy of nested nodes that represent the structures of one or more of the custom user interface or the new user interface, in an embodiment. In embodiments, the method comprises identifying a conflict between at least one of the nested nodes in the baseline tree relative to at least one of the nested nodes in the intermediate tree. In accordance with the media, the method concurrently presents a user-interactive visual representation of the baseline tree and the intermediate tree via a graphical user interface (GUI), wherein one or more nested nodes in the intermediate tree is annotated with a conflict resolution icon to represent the conflict identified. In an embodiment, the method comprises dynamically updating the intermediate tree in the GUI in response to a user-interaction with the GUI designating a resolution to the one or more conflicts. In response an indication to finalize the intermediate tree, the method comprises performing a validation logic against the intermediate tree to identify errors. In embodiments, the method encodes the hierarchy of nested nodes of the intermediate tree to create a finalized user interface that is a merger of the structures of one or more of the custom user interface and the new user interface when the validation logic successfully runs without identifying an error.

### BRIEF DESCRIPTION OF THE DRAWINGS

Embodiments are described in detail below with reference to the attached drawings figures, wherein:

FIG. 1 is a flow diagram of an exemplary method in accordance with an embodiment of the present invention;

FIG. 2 is a flow diagram of an exemplary method in accordance with an embodiment of the present invention;

FIG. 3 is a flow diagram of an exemplary method in accordance with an embodiment of the present invention;

FIG. 4 depicts an exemplary graphical user interface (GUI) in accordance with embodiments of the present invention;

FIG. 5 depicts an exemplary GUI in accordance with embodiments of the present invention;

FIG. 6 depicts an exemplary GUI in accordance with embodiments of the present invention;

FIGS. 7A-7D depict exemplary GUIs in accordance with embodiments of the present invention;

FIG. 8 depicts an exemplary GUI in accordance with embodiments of the present invention;

FIG. 9 depicts an exemplary GUI in accordance with embodiments of the present invention;

FIG. 10 depicts an exemplary GUI in accordance with embodiments of the present invention;

FIG. 11 depicts an exemplary GUI in accordance with the embodiments of the present invention;

FIG. 12 depicts an exemplary GUI in accordance with embodiments of the present invention;

FIG. 13 depicts an exemplary GUI in accordance with embodiments of the present invention; and

FIG. 14 depicts a block diagram of an exemplary environment suitable to implement embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide a hierarchy editor with a user-interactive graphical user interface (GUI). At a high level, the hierarchy editor tool builds hierarchical structures from computer source code for user interfaces, streamlines editing of the hierarchical structures, performs conflict checking between hierarchical structures, performs validation of edited hierarchical structures, and subsequently encodes finalized edited hierarchical structures into computer source code to create new user interfaces. This is a paradigm shift from prior technologies, which only presented lines of alphanumeric and syntax symbols of computer source code itself in a conventional .xml or .txt format, for example. In prior technologies, the computer source code was searchable at best. Yet, the only way to make changes to a user interface, for example, was to directly modify the text of the computer source code itself. As such, embodiments of the present invention provide a technological improvement over prior technologies by generating and editing hierarchies of nested nodes that represent user interfaces and source code, without requiring any direct contact with the source code itself. Prior technologies failed to provide any such hierarchical structure for source code. Thus, the embodiments of the present invention also perform new technological actions that prior technologies could not preform. As used herein “source code,” “program code,” and “code” are used interchangeably.

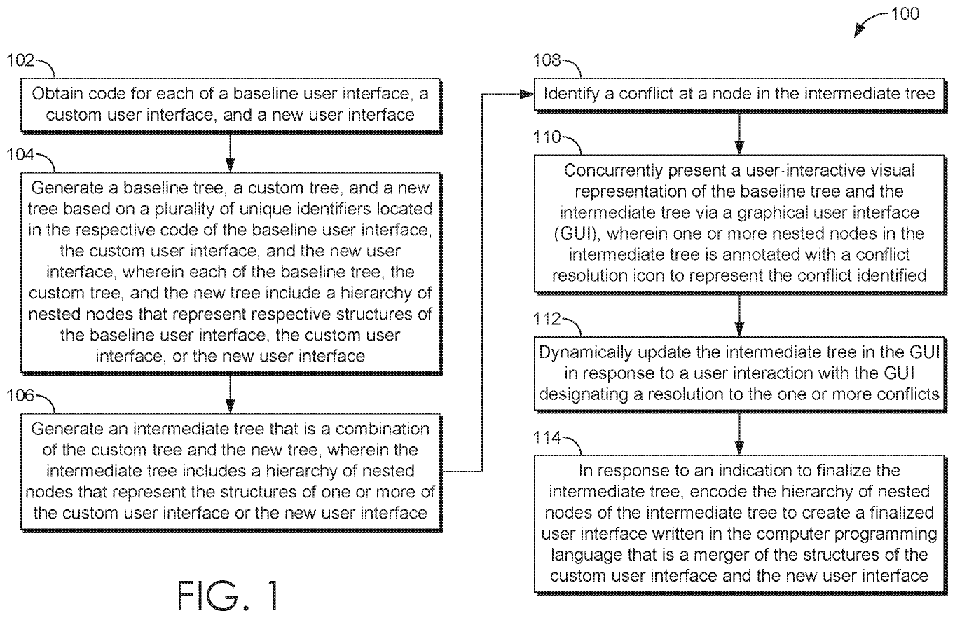

Turning now to FIG. 1, FIG. 1 is a flow diagram of an exemplary method 100 in accordance with an embodiment of the present invention. In some embodiments, the method 100 is performed by execution of computer-executable instructions embodied on one or more non-transitory computer-readable media. The method 100 may be performed by a hierarchy editor tool which may be accessed via an interactive user interface. The method 100 comprises obtaining code for each of a baseline user interface, a custom user interface, and a new user interface, shown at block 102. In embodiments, the code for one or more of the baseline user interface, a custom user interface, and a new user interface may be retrieved, received, imported, downloaded, uploaded to the hierarchy editor tool, and/or otherwise shared with the hierarchy editor tool over any wired or wireless connection.

For the purposes of this discussion, the baseline user interface refers to a user interface for which the source code provides an initial reference point or a “baseline” with regard to structures and value(s) defining the parameter(s) for each structure. The custom user interface refers to a user interface for which at least one structure and value(s) defining the parameter(s) for each structure has been modified or “customized” by a user implementing the user interface. For example, a user has created the custom user interface by making several changes to the baseline user interface, by adding new structures, removing or omitting existing structures, moving the placement, sequence, or order of structures, changing the values for structure parameters, rewriting HTML or script, etc., such that the custom user interface is truly customized to the desires of the user. The custom user interface is, generally, a user interface that the user has installed, has implemented, and/or is currently in use by the user. The new user interface refers to a user interface to be installed, in one embodiment. In another embodiment, the new user interface refers to a user interface that has been installed but is to be modified through the hierarchy editor tool. The new user interface may comprise different structures and value(s) defining the parameter(s) for each structure, dependence or sequence of structures, etc., relative to one or more of the baseline user interface and the custom user interface. It will understood that the terms baseline, custom, and new are therefore somewhat arbitrary in nature, as the terms are used herein for clarity to designate user interfaces that vary in structure, dependence or sequence of structures, and/or values defining the parameter(s) for each structure. At a high level, the baseline user interface, the custom user interface, and the new user interface are not the same in embodiments discussed here, albeit each might share some of the same or similar structure(s) and/or value(s) thereof. For example, the baseline user interface and the new user interface might have at least one structure in common, but each may have different value(s) for the parameter(s) corresponding to the structure. In additional examples, the custom user interface might lack a structure that is present in the baseline user interface, and/or the new user interface might have a new structure that is not present in the custom user interface, etc. Thus, the interfaces may or may not share some portion of corresponding structures in various scenarios.

Continuing, at block 104, the method 100 generates a baseline tree, a custom tree, and a new tree based on a plurality of unique identifiers located in the respective code of the baseline user interface, the custom user interface, and the new user interface. The method 100 may extract the unique identifiers of the structures(s) and value(s) defining parameters for the structure(s), in further embodiments. In embodiments, each of the baseline tree, the custom tree, and the new tree include a hierarchy of nested nodes that represent respective structures of the baseline user interface, the custom user interface, or the new user interface. The tree is a hierarchical representation of the source code of the user interface. A tree comprises one or more nodes. For example, each node is a “branch” connected to a “trunk” of the tree. Nodes may be nested within other nodes as well. For example, one node may branch off another node, and so on, until one of the nodes connects to the trunk of the tree. Generally, each node represents a structure encoded in the source code for a user interface. The nesting and/or location of a node in the tree relative to other nodes and the trunk of the tree represent(s) the order and dependence of the structures (represented by the nodes) within the source code relative to other structures within the source code, for example. It will be understood from this discussion that, while a tree represents the structure of structures encoded in the source code of a user interface and a node represents a discrete structure and/or a value defining a parameter for a structure encoded in the source code of the user interface, it may be stated, for simplicity, that a tree and its nodes represent a user interface. Additionally, it will be understood from this description that source code is a flat representation of a user interface in computer memory whereas a tree is a hierarchal representation of a user interface in computer memory.

In order to form each of the baseline tree, the custom tree, and the new tree from the source code of the baseline user interface, the custom user interface, and the new user interface, the method 100 reads the source code of baseline user interface, the custom user interface, and the new user interface. For each of the baseline user interface, the custom user interface, and the new user interface, the method 100 locates a plurality of unique identifiers in the code that correspond to structures of one or more of the baseline user interface, the custom user interface, and the new user interface. Each unique identifier in the code corresponds to a specific structure, enabling the method 100 to distinguish between different structures in the source code. For example, the method 100 locates a plurality of unique identifiers within the source code of the baseline user interface, locates a plurality of unique identifiers within the source code of the custom user interface, and locates a plurality of unique identifiers located in the code of the new user interface, in embodiments. Using the plurality of unique identifiers, the method 100 builds, creates, and/or generates a hierarchy tree for each user interface with nodes representing the structures and/or value(s) for structures.

Generally, one tree represents one user interface. As such, the method 100 builds, creates, and/or generates three distinct trees, one for each of the baseline, custom, and new user interfaces. Within one tree, each structure is represented by one node, and each value defining a parameter for a particular structure is represented with one node, that node being nested under or within the one node that represents the corresponding structure being defined with the value. Therefore, values for parameters are nested within the node of the corresponding structure being defined by those values. In further examples, one node for a structure may be nested under or within another node for another structure, based on dependence and/or order within the source code of the user interface. Structures that are independent of other structures in the source code will generally branch directly from the trunk of the tree.

Once the hierarchical trees are generated for the baseline tree, the custom tree, and the new tree, the structure of the nodes within the hierarchical trees are assessed. It should be noted that the hierarchical trees, not the source code, are being examined in accordance with the method 100. In embodiments, the method 100 determines whether each node located in the baseline tree is present, absent, or at a different relative location within the custom tree. The method 100 determines whether each node located in the baseline tree is present, absent, or at a different relative location within the new tree, in embodiments. For example, the method 100 determines whether the custom tree and the baseline tree both include a node for a first structure. The method 100 further determines whether the new tree and the baseline tree both include the node for a first structure, for example.

In embodiments, when a nested node in the baseline tree is present in the custom tree, the method 100 determines that a structure of the baseline user interface corresponding to the nested node is conserved in the custom user interface. However, in embodiments, the location of the node within the custom tree may be different than the location of the same node within the baseline tree. For example, when a nested node is present in the baseline tree and the custom tree, and yet the nested node has a different location in the baseline tree relative to the location of the nested node in the custom tree, the method 100 determines a location and/or dependence of a structure of the baseline user interface is modified relative to the custom user interface. In another embodiment, when a nested node in the baseline tree is present in the custom tree, the method 100 may determine that a value defining a parameter of a corresponding structure of the baseline user interface corresponding to the nested node is conserved in the custom user interface.

When a nested node in the baseline tree is absent in the custom tree, the method 100 determines that a structure of the baseline user interface corresponding to the nested node is omitted from the custom user interface. In one embodiment, when a nested node in the baseline tree is absent in the custom tree, the method 100 determines that a value defining a parameter(s) for a corresponding structure of the baseline user interface corresponding to the nested node has been deleted, removed, and/or omitted from the custom user interface. In the reverse, when a nested node in the custom tree is not present in the baseline tree, the method 100 determines that a structure or a value defining a parameter for a structure corresponding to the nested node was added to the custom user interface, relative to the baseline user interface. It is noted here again that a node represents a discrete structure and/or a value defining a parameter for a structure encoded in the source code of the user interface. Thus, in one embodiment, when a nested node that represents a parameter value (e.g., an attribute of a node) in the baseline tree is absent in the custom tree, the method 100 determines that the parameter value of a corresponding structure of the baseline user interface has been deleted, removed, and/or omitted from the custom user interface.

In addition to assessing the custom tree, the method 100 examines the new tree relative to the baseline tree in the same fashion as explained above with regard to the custom tree. Similar to that explained above, when a nested node in the baseline tree is present in the new tree, the method 100 determines a structure of the baseline user interface corresponding to the nested node is conserved in the new user interface. And when a nested node in the new tree is not present in the baseline tree, the method 100 determines a structure corresponding to the nested node was added to the new user interface relative to the baseline tree. It will be understood upon reading this disclosure that assessment of the new tree is similar to the hierarchy editor tool determinations described above. These determinations are not discussed in detail herein regarding the new tree for brevity and reduced redundancy.

The method continues by assessing every node in the baseline tree, the custom tree, and the new tree and making those determinations described above. Based on these assessments and determinations, the method 100 identifies any and/or all differences between the nodes of the baseline tree relative to corresponding, absent, or added nodes of the custom tree and corresponding, absent, or added nodes in the new tree.

At block 106, the method 100 generates an intermediate tree. The intermediate tree represents a combination of nodes of the custom tree and the new tree, those nodes being based on the plurality of unique identifiers located in the code of the custom user interface and the plurality of unique identifiers located in the code of the new user interface. Accordingly, the intermediate tree includes a hierarchy of nested nodes that represent the structures of one or more of the custom user interface or the new user interface. Once the intermediate tree is generated, the method 100 assesses the intermediate tree for node conflicts.

At block 108, the method 100 identifies that there is a conflict via the intermediate tree. A conflict arises between at least one of the nested nodes in the baseline tree relative to at least one of the nested nodes in the intermediate tree. A conflict is identified when presence, absence, and/or relative location of a nested node in the custom tree for a particular structure in the custom user interface and a presence, absence, and/or relative location of a nested node of a corresponding nested node in the new tree for the particular structure in the new user interface are both different from presence, absence, and/or relative location of a corresponding node in the baseline tree for the particular structure in the baseline user interface. In simpler terms, a conflict is identified when both the custom tree and the new tree exhibit a difference from the baseline tree for the same node. Generally, recall that the node represents a structure or a parameter value for a structure. A conflict is not identified in the intermediate tree when only one of the new tree and the custom tree exhibit a presence, absence, and/or relative location change of a nested node relative to the baseline tree. When no conflict is identified, the method 100 automatically selects the node, from either the custom tree or the new tree, which is different from the baseline tree. This automatically selected conflict-free node is provided in the intermediate tree.

At a high level, the intermediate tree represents the structures and values of a user interface that will be created through the hierarchy editor tool. The intermediate tree is not the same as the baseline tree, the custom tree, and the new tree. The intermediate tree provides a preview of the structures and values of a future user interface to be created in accordance with the method 100.

At block 110, the method 100 concurrently presents a user-interactive visual representation of the baseline tree and the intermediate tree via a graphical user interface (GUI). In the GUI, the intermediate tree includes a visual indicator of a conflict at each node where a conflict is identified in accordance with the method 100. Accordingly, one or more nested nodes in the intermediate tree is annotated with a conflict resolution icon to represent the conflict identified, in an embodiment. A conflict resolution icon is a visual indicator that a conflict exists and should be resolved. Via the GUI, the method 100 may concurrently present a user-interactive visual representation of the baseline tree and the intermediate tree, for a side-by-side view, for example. In such an example, the table includes, for each conflict identified and annotated in the intermediate tree, a selectable option for a nested node representing the custom tree and another selectable option for a corresponding nesting node in the new tree. As such, a user interacting with the hierarchy editor tool, for example, may select one or the other value to designate a desired value for the nested node.

At block 112, the method 100 dynamically updates the intermediate tree in the GUI in response to a user interaction with the GUI designating a resolution to the one or more conflicts. For example, a user selection of a value from the intermediate tree, that value corresponding to the custom tree, is received. Based on the user selection via the GUI, the method 100 updates the intermediate tree to indicate that the conflict is resolved and the value corresponding to the custom tree is designated within the intermediate tree presented via the GUI. In embodiments wherein the GUI includes a table, the method 100 may include receiving an indication of a user selection in the table of one of the selectable options for the nested node in the custom tree or the selectable option for a corresponding nesting node in the new tree. It will be understood that only one of the selectable options may be selected. Generally, the intermediate tree is dynamically updated in the GUI to reflect the user selection of one of the selectable option for the nested node in the custom tree or the selectable option for a corresponding nesting node in the new tree.

Once all conflicts have been resolved, the method 100 may activate a merge function and activate a corresponding button presented via the GUI. The intermediate tree cannot be finalized until no conflicts remain. Through the merge function, the conflict-free intermediate tree is used to build a finalized user interface. For example, a user may select the button via the GUI to initiate the merge function and create source code for a finalized user interface from the conflict-free intermediate tree. The user selection may be received by the hierarchy editor tool as a finalization indication. Accordingly, at block 114, in response to an indication to finalize the intermediate tree, the method 100 encodes the hierarchy of nested nodes of the intermediate tree to create a finalized user interface written in a computer programming language. At a high level, the method 100 reverse engineers the finalized intermediate tree into a finalized user interface by writing source code that reflects the nodes and node organization represented by the finalized intermediate tree. In embodiments, the finalized user interface that is created is a merger of one or more of structures of the custom user interface and the new user interface based on the selections received via the GUI.

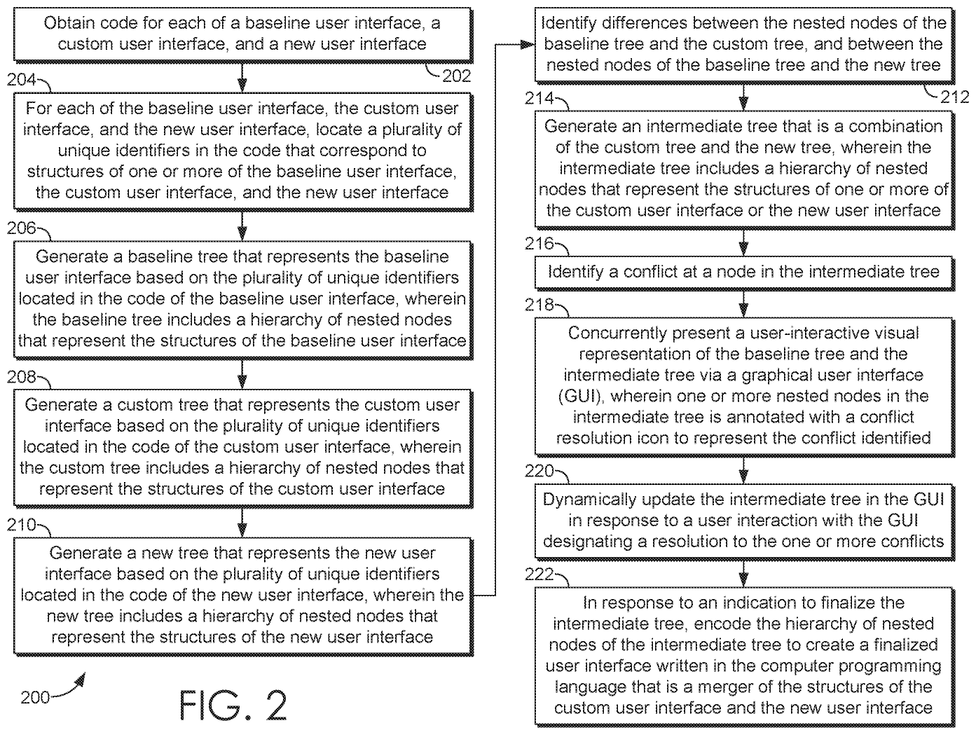

Continuing to FIG. 2, FIG. 2 is a flow diagram of an exemplary method 200 in accordance with an embodiment of the present invention. In some embodiments, the method 200 is performed by execution of computer-executable instructions embodied on one or more non-transitory computer-readable media. It will be understood that some or all of the features described above with regard to the method 100 of FIG. 1 may also be implemented in the method 200 of FIG. 2. Beginning at block 202, the method 200 obtains code for each of a baseline user interface, a custom user interface, and a new user interface. As previously described, the source codes for the user interfaces may be loaded in the hierarchy editor tool, in embodiments.

For each of the baseline user interface, the custom user interface, and the new user interface, the method 200 locates a plurality of unique identifiers in the respective source code. The code corresponds to structures of one or more of the baseline user interface, the custom user interface, and the new user interface, as shown at block 204. Then, at block 206, the method 200 generates a baseline tree that represents the baseline user interface based on the plurality of unique identifiers located in the code of the baseline user interface. The baseline tree includes a hierarchy of nested nodes that represent the structures of the baseline user interface. At block 208, the method 200 generates a custom tree that represents the custom user interface based on the plurality of unique identifiers located in the code of the custom user interface. The custom tree includes a hierarchical tree of nested nodes that represent the structures of the custom user interface, in an embodiment. At block 210, the method 200 generates a new tree that represents the new user interface based on the plurality of unique identifiers located in the code of the new user interface. In an embodiment, the new tree includes a hierarchy of nested nodes that represent the structures of the new user interface.

At block 212, the method 200 identifies differences between the nested nodes of the baseline tree and the custom tree, and identifies differences between the nested nodes of the baseline tree and the new tree. In embodiments, the method 200 determines whether each node located in the baseline tree is present, absent, or at a different relative location within the custom tree, and further determines whether each node located in the baseline tree is present, absent, or at a different relative location within the new tree.

Next, at block 214, the method 200 generates an intermediate tree that is a combination of the nodes of the custom tree and the new tree. In an embodiment, the intermediate tree includes a hierarchy of nested nodes that represent the structures of one or more of the custom user interface or the new user interface. At block 216, the method 200 identifies a conflict in the intermediate tree. One or more conflicts are identified when one or more of presence, absence, or relative location of a nested node in the custom tree for a particular structure in the custom user interface and a corresponding nested node in the new tree for the particular structure in the new user interface are different from one or more of presence, absence, or relative location of the same corresponding node in the baseline tree for the particular structure in the baseline user interface.

At block 218, the method 200 concurrently presents a user-interactive visual representation of the baseline tree and the intermediate tree via a graphical user interface (GUI). The nodes of the intermediate tree may be presented with labels that identify the node and/or the structures and/or parameter values being represented at that node. In an embodiment, one or more nested nodes in the intermediate tree are annotated with a conflict resolution icon to represent the one or more conflicts identified. The method 200 presents, in the nested nodes of the intermediate tree displayed via the GUI, and for each of the one or more conflicts identified, a type icon specifying an addition, a deletion, a location change, or a script edit for the nested node in the custom tree, and a type icon specifying an addition, a deletion, a location change, or a script edit for the nested node in the new tree. The type icon indicates how the node in the custom tree differs from the baseline tree and how the node in the new tree differs from the baseline tree. In some embodiments, the method 200 concurrently presents a table with the user-interactive visual representation of the baseline tree and the intermediate tree via the GUI. In such an embodiment, the table may display a conflict icon for each of the one or more conflicts identified, and the table may provide information for the node of the custom tree and the node of the new tree.

At block 220, the method 200 dynamically updates the intermediate tree presented in the GUI in response to a user interaction with the GUI designating a resolution to the one or more conflicts. For example, a user selection of an option at the conflicted node from the intermediate tree, that selection choosing a node from the custom tree as opposed to a node from the new tree, for example, is received. (It will be understood that one might select an option for a node from the new tree as opposed to a node from the custom tree instead, and this is merely an example.) Based on the user selection via the GUI, the method 200 updates the intermediate tree to indicate that the conflict is resolved by the indication received and the selected option is designated within the intermediate tree as updated and presented via the GUI. The other selectable option at the conflicted node is no longer presented in the intermediate tree.

Once all conflicts within the intermediate tree have been resolved, the intermediate tree may be finalized. At block 222, in response to an indication to finalize the intermediate tree, the method 200 performs encoding of the hierarchy of nested nodes of the intermediate tree to create a finalized user interface written in a computer programming language. The finalized user interface is a merger of the structures of one or more of the custom user interface and the new user interface, including those structures chosen to resolve the one or more conflicts identified.

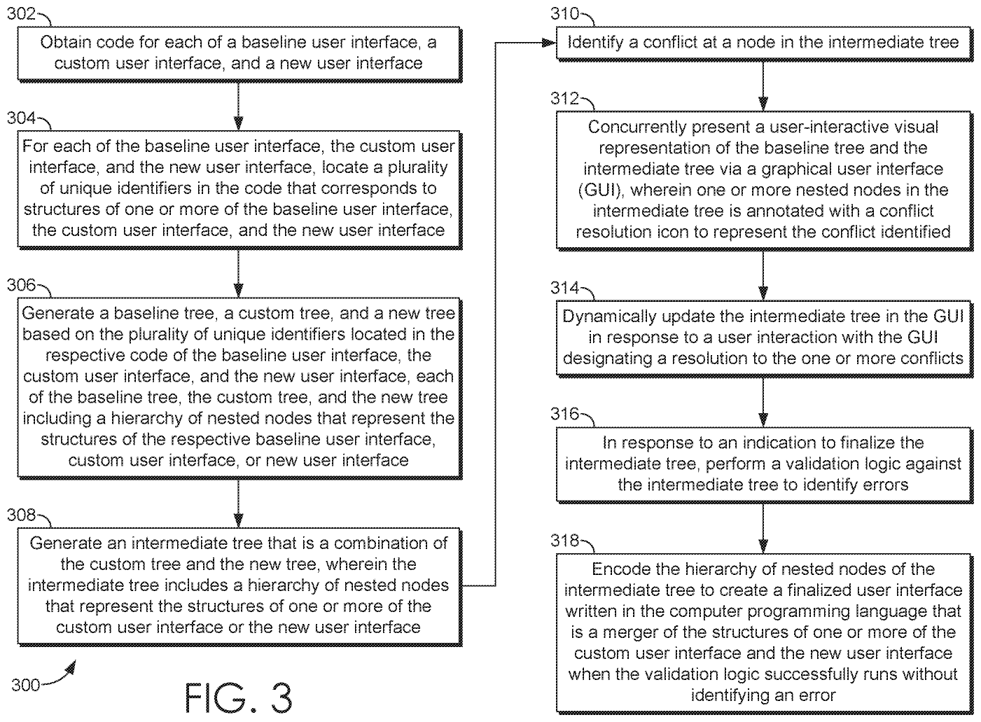

FIG. 3 is a flow diagram of an exemplary method 300 in accordance with an embodiment of the present invention. In some embodiments, the method 300 is performed by execution of computer-executable instructions embodied on one or more non-transitory computer-readable media. It will be understood that some or all of the features described above with regard to the method 100 of FIG. 1 may also be implemented in the method 300 of FIG. 3. Turning to block 302, the method 300 obtains code for each of a baseline user interface, a custom user interface, and a new user interface.

At block 304, for each of the baseline user interface, the custom user interface, and the new user interface, the method 300 locates a plurality of unique identifiers in the code that corresponds to structures of one or more of the baseline user interface, the custom user interface, and the new user interface. At block 306, the method 300 generates a baseline tree, a custom tree, and a new tree based on the plurality of unique identifiers located in the respective code of the baseline user interface, the custom user interface, and the new user interface, as previously described herein. Each of the baseline tree, the custom tree, and the new tree include a hierarchy of nested nodes that represent the structures of the respective baseline user interface, custom user interface, or new user interface, in embodiments.

At block 308, the method 300 generates an intermediate tree that is a combination of the nodes of the custom tree and the new tree. The intermediate tree includes a hierarchy of nested nodes that represent the structures of one or more of the custom user interface or the new user interface, in an embodiment. The method 300 may automatically select a nested node in the custom tree for inclusion in the intermediate tree when the nested node in the custom tree is different from a corresponding node in the baseline tree and a corresponding nested node in the new tree is the same as the corresponding node in the baseline tree. The method 300 may automatically select a nested node in the new tree for inclusion in the intermediate tree when the nested node in the new tree is different from a corresponding node in the baseline tree and a corresponding nested node in the custom tree is the same as the corresponding node in the baseline tree. However, the method 300 may recognize that, at this time or subsequently during finalization of the intermediate tree, automatically selected nodes are incompatible with one another when an action to one node selected from the custom tree cannot be performed with another action to a node selected from the new tree.

At block 310, the method 300 identifies a conflict in the intermediate tree. In accordance with the media, at block 312, the method 300 concurrently presents a user-interactive visual representation of the baseline tree and the intermediate tree via a graphical user interface (GUI), wherein one or more nested nodes in the intermediate tree is annotated with a conflict resolution icon to represent the conflict identified. At block 314, the method 300 dynamically updates the intermediate tree in the GUI in response to a user interaction with the GUI designating a resolution to the one or more conflicts.

At block 316, in response to an indication to finalize the intermediate tree for which no conflicts remain, the method 300 performs a validation logic against the intermediate tree to identify errors. For example, the method 300 may recognize that automatically selected nodes are incompatible with one another when an action to one node selected from the custom tree cannot be performed with another action to a node selected from the new tree. In such an instance, the method 300 identifies an error based on the incompatibility of the automatically selected nodes. Performing a validation logic against the intermediate tree to identify errors, the method 300 may further include determining whether automatically selected nested nodes are incompatible with one another and generating an error when automatically selected nested nodes are incompatible with one another. In an embodiment, performing a validation logic against the intermediate tree to identify errors, per the method 300, further comprises providing a description of each error for display via the GUI when it is determined that automatically selected nested nodes are incompatible with one another. In embodiments, the errors are addressed via the GUI with indications of user selections and/or through the method 300 identifying errors that can be solved automatically. For example, if the method 300 automatically selected that a node be removed from the intermediate tree for a structure and the method 300 automatically selected a node that corresponded to a parameter value for the structure to be removed, the method 300 may automatically correct the error and disregard the selection of the parameter value node because the structure node is being removed and the parameter value is not applicable in view of this.

Having resolved all conflicts and all errors, at block 318, the method encodes the hierarchy of nested nodes of the intermediate tree to create a finalized user interface written in a computer programming language when the validation logic successfully runs without identifying an error. A high level, the finalized user interface is a merger of the structures of the custom user interface and the new user interface. It will be understood that the method 300 may also recognize when user-selected nodes are incompatible with one another for the same or similar reasons as those discussed above. In one instance, the method 300 identifies an error based on the incompatibility of the user-selected nodes. In such instances, the steps and remedies above in the method 300 further apply to incompatibilities of user-selected notes such that the incompatibilities may be resolved in the same or similar manner.

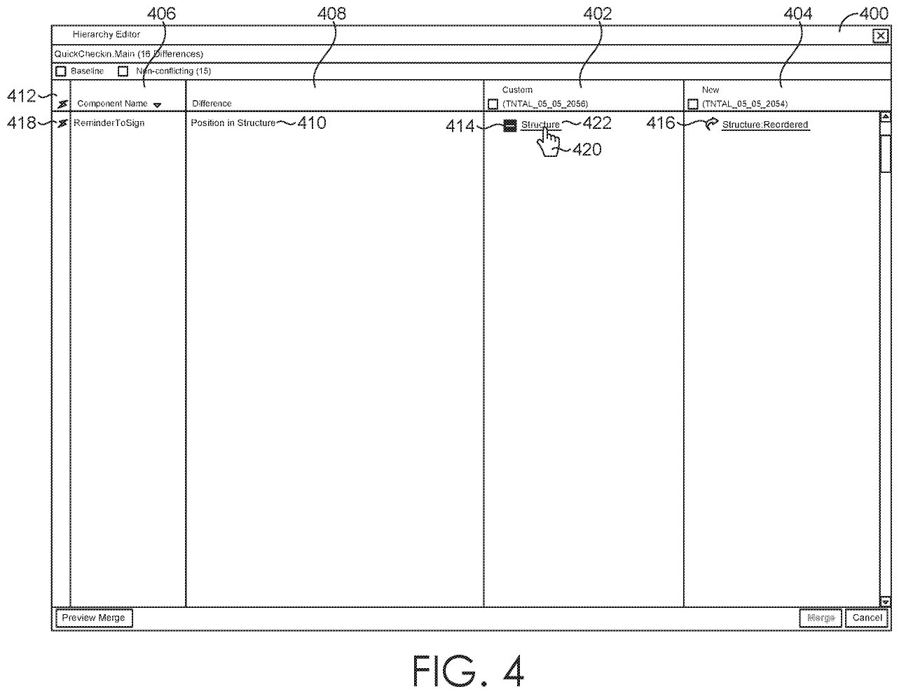

FIG. 4 depicts an exemplary graphical user interface (GUI) in accordance with embodiments of the present invention. The exemplary GUI 400 shown in FIG. 4 enables user interaction with the hierarchy editor tool performing the exemplary methods 100, 200, and 300, for example. In the example illustrated, the GUI 400 provides one column 402 corresponding to the custom user interface and one column 404 corresponding to the new user interface, for which source code has been obtained for each and loaded into the hierarchy editor tool. In an embodiment, a header for column 402 displays a unique identifier for the custom user interface (“TNTAL_05_05_2056”) corresponding to the source code obtained. A header for column 404 displays a unique identifier for the new user interface (“TNTAL_05_05_2054”) corresponding to the source code obtained, in an embodiment. Generally, structures and parameter values of the custom user interface are presented in rows below column 402 and structures and parameter values of the new user interface are presented in rows below column 404.

The GUI 400 also displays a component identification column 406, an editor determination column 408, and an editor determination icon column 412. In the example shown in FIG. 4, a node uniquely identified as “ReminderToSign” is presented in a first row under the component identification column 406, and information for the same node is presented in the same row under the column 402 for the custom tree, the column 404 for the new tree, and the editor determination column 408. For example, a unique identifier (“ReminderToSign”) for a node is shown under the component identification column 406 and a detailed description of a determination (e.g., description 410 “Position In Structure”) of a node conflict is presented under the editor determination column 408, wherein the determination was made by the hierarchy editor tool as discussed previously with regard to methods. An icon that visually represents a conflict is presented in the editor determination icon column 412. For example, a lightning bolt shaped icon 418 visually represents that there is a node conflict in the editor determination icon column 412, placed alongside the component identification column 406. In the example, an icon visually representing the presence, absence, addition, movement, etc., for the node in the custom tree is presented in column 402 and an icon visually representing the presence, absence, addition, movement, etc., of the node in the new tree is presented in column 404. For example, the node was removed from the custom tree relative to the baseline tree and the node was moved in location within the new tree relative to the baseline tree. As such, a deletion icon 414 is presented in column 402 to represent the node in the custom tree and a location change icon 416 is presented in column 404 to represent the node in the new tree. In addition, descriptive text may be presented with icons in respective columns to further indicate details regarding the node in each tree. For example, the selectable linking text 422 (“Structure”) is shown in column 402 to represent a node in the custom tree, along with the deletion icon 414 representing the deletion of that particular node in the custom tree. The color of linking text may be different from non-linking text in the GUI 400 to distinguish the linking text for a viewer.

In embodiments, a selection tool 420 may be manipulated and moved around areas of the GUI 400 in order for a viewer to interact with the hierarchy editor tool. For example, a selection of one or more selectable items may be performed such that, when selected, one or more pop-up windows or “panes” are generated. In embodiments, the pop-up windows or panes may be concurrently presented within GUI 400 so that the view of the GUI 400 remains unobstructed.

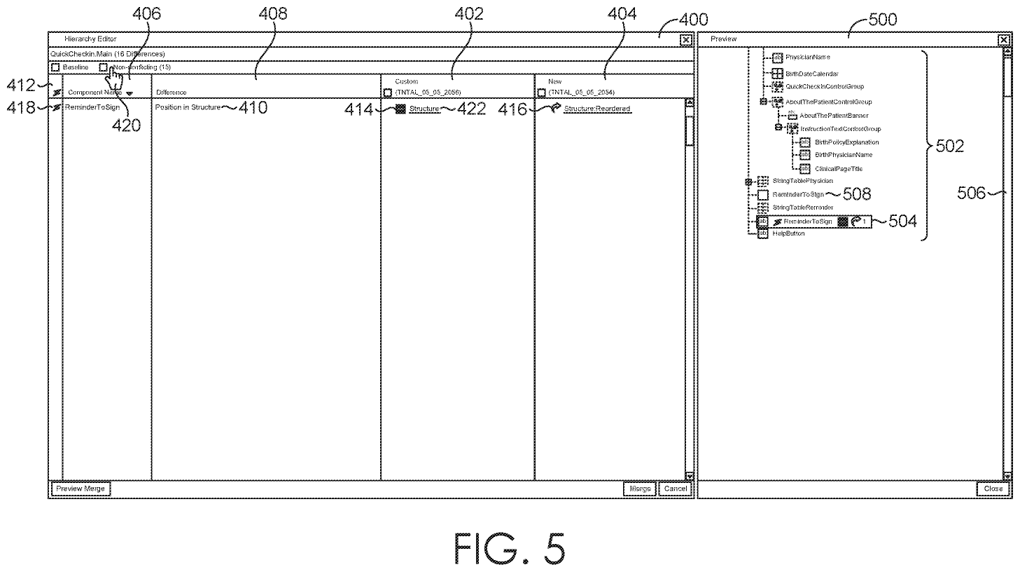

FIG. 5 depicts an exemplary GUI, in accordance with embodiments of the present invention. In FIG. 5, a preview pane 500 is generated and displayed in response to a selection of the selectable linking text 422 for a node from column 402 for the custom tree in GUI 400. The preview pane 500 provides more in-depth interaction with the hierarchy editor tool. In embodiments, the preview pane 500 presents the intermediate tree 502 that is generated by the hierarchy editor tool. As such, the preview pane 500 can be generated from a section within either column 402 for the custom tree or column 404 for the new tree. The preview pane 500 specifically presents, at least, a portion of the intermediate tree 502 that includes a first node 504 “ReminderToSign” that corresponds to the selectable linking text 422 that was selected from column 402. (As used herein, the term “first” is merely being used to distinguish this particular node from the other nodes in a tree, and the term does not convey any particular order in the hierarchy of a tree or any particular prominence.) Accordingly, by selecting linking text, a viewer is able to “jump” to a specific node within the intermediate tree 502 presented in the preview pane 500. The specific node may be highlighted in color, a shaded box, an outlined box, or underlined, in some way to visually indicate the node's selection via the linking text. As shown in FIG. 5, only a portion of the intermediate tree 502 is presently visible in the preview pane 500. A viewer may use a scrollbar 506 to scroll up or down to view other portions in the intermediate tree 502, for example.

In the intermediate tree 502, the first node 504 “ReminderToSign” that corresponds to the selectable linking text 422 that was selected from column 402 is presented with icons. In the preview pane 500, the first node 504 is presented with an icon visually representing a node conflict, an icon visually representing treatment of the first node 504 within the custom tree, another icon visually representing the treatment of the same first node 504 within the new tree. For example, a deletion icon is presented with the first node 504 to designate that the first node 504 was deleted from the custom tree relative to the baseline tree. In the same example, another icon is presented with the first node 504 to designate that the first node 504 was moved in location in the new tree relative to the baseline tree. Thus, in the intermediate tree 502, the unique identifier of the node is presented alongside several icons that tell the story of the nodes presence, absence, location, and/or other changes within the custom tree and the new tree, relative to the baseline tree.

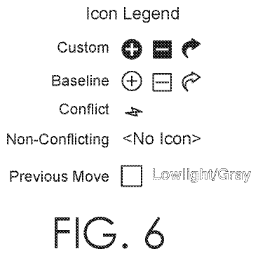

FIG. 6 depicts an exemplary table of icons, in accordance with embodiments of the present invention. Generally, all icons that visually represent the addition of a node may be circular in shape with an interiorly located plus (“+”) symbol, for example. In another example, all icons that visually represent the deletion of a node may be rectangular or square in shape with an interiorly located minus (“−”) symbol. In yet another example, all icons that visually represent a location change of a node may be an arrow shape. Conserving shapes or symbols of the icons enables consistency and understanding of node treatments within various trees. In additional embodiments, a prior location of a node within a tree may be presented with a lowlight. For example, in FIG. 5, a node 508 is displayed in the intermediate tree 502 to indicate where the first node 504 was located prior to being moved within the new tree, relative to the baseline tree. In this way, another layer of information is presented in the preview pane 500. As shown, the node 508 is provided as a visual effect of lowlighted text, to designate that this is a prior location for the node 508. In embodiments, a lightning bolt shaped icon visually represents that a node conflict exists between trees.

However, the icons representing node treatment in the custom tree may have a different visual indication (i.e., a different color, different shade, different color fills within icon shapes) than the icons representing node treatment in the new tree. For example, all icons having a solid color fill of the icon shape may be associated with the custom tree whereas all icons having an outline and no color fill of the icon shape may be associated with the new tree. In another example, all icons having a blue color filling the shape may be associated with the custom tree whereas all icons having a black color filling the shape may be associated with the new tree. In this way, the icons in the preview pane 500 can be readily attributed to either the custom tree or the new tree without confusion by a viewer. For example, deletion icon 414 in GUI 400 exhibits a solid color fill in column 402 for the custom tree and the deletion icon is again shown, this time in the intermediate tree 502, with a solid color fill at the first node 504 to indicate that the first node 504 was removed from the custom tree, relative to the baseline tree. Similarly, the location change icon 416 in GUI 400 exhibits an outline and no color fill in column 404 for the new tree and the location change icon is again shown, this time in the intermediate tree 502, with the same outline and no color fill at the first node 504 to indicate that the first node 504 was moved in location within the new tree, relative to the baseline tree, for example.

Continuing, a selection tool 420 may be manipulated and moved around areas of the GUI 400 in order for a viewer to interact with the hierarchy editor tool. For example, a selection of one or more selectable items may be performed such that, when selected, they generate and display determinations of the hierarchy editor tool. The selection tool 420 may be used to manipulate and/or activate a display of aspects of the baseline tree and non-conflicting nodes in the GUI 400, for example, in addition to conflicting nodes that are being presented. For example, in response to a selection of a graphic object, such as box 702 “Baseline” and/or box 704 “Non-conflicting,” the columns of the GUI 400 will be populated with information from the hierarchy editor tool.

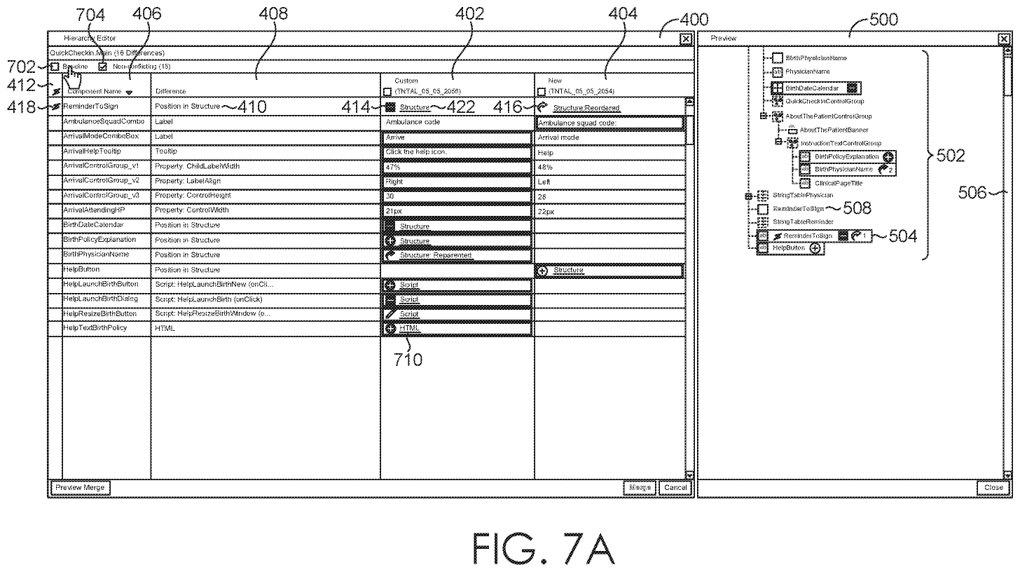

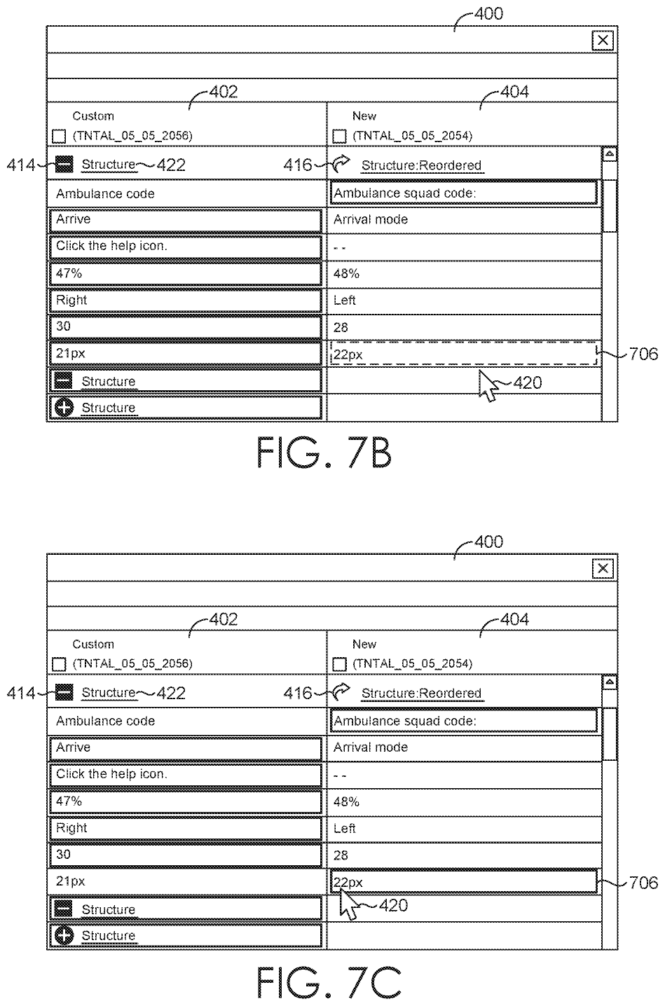

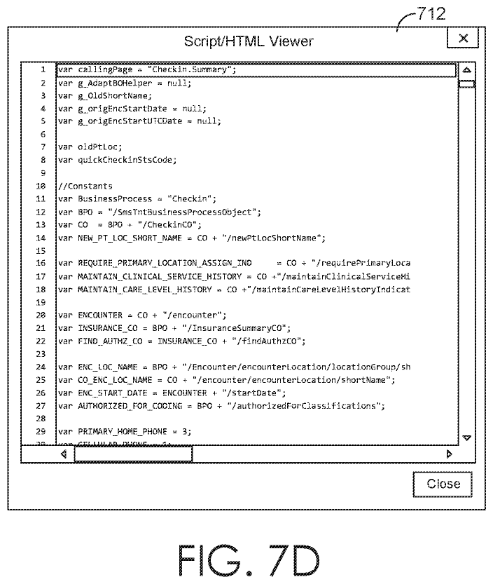

In response to a selection of the box 704 “Non-conflicting” in GUI 400, the GUI 400 displays additional nodes for which the hierarchy editor tool has determined that no conflict exists. Turning to FIG. 7A, which depicts an exemplary GUI in accordance with embodiments of the present invention, rows have been added beneath the columns, each row corresponding to a distinct or different node for which no conflict is present. As is apparent in FIG. 7A, the editor determination icon column 412 does not include a conflict icon for these conflict-free nodes. Although these nodes are conflict free, the presence, absence, location, etc., of these nodes still varies from the baseline tree. For example, the editor determination column 408 displays a detailed description of a conflict-free determination for each node, as made by the hierarchy editor tool. Exemplary descriptions include Position in Structure, Label, Tooltip, Script, Property, and HTML. Exemplary descriptions may include subcategories such as Property: ChildLabelWidth, Property: LabelAlign, Property:ControlHeight, Script:HelpLaunchBirth, and so on. These descriptions indicate how a corresponding node in either the custom tree or the new tree has been edited relative to the baseline tree. As discussed above, structures and parameter values of the custom user interface are presented in rows below column 402 and structures and parameter values of the new user interface are presented in rows below column 404, regarding the non-conflicting nodes. For example, node “Property:ChildWidthLabel” has a value of 47% in the custom tree and a value of 48% in the new tree, as shown in the respective columns 402 and 404. As displayed, these values may be selectable options as discussed further below.

As discussed hereinabove, the hierarchy editor tool automatically selects a nested node in the custom tree for inclusion in the intermediate tree when the nested node in the custom tree is different from a corresponding node in the baseline tree and a corresponding nested node in the new tree is the same as the corresponding node in the baseline tree. Additionally, the hierarchy editor tool automatically selects a nested node in the new tree for inclusion in the intermediate tree when the nested node in the new tree is different from a corresponding node in the baseline tree and a corresponding nested node in the custom tree is the same as the corresponding node in the baseline tree. Accordingly, the editor determination column 408 displays a detailed description of each of these nodes automatically selected by the hierarchy editor tool based on a determination of no conflict. For example, the node uniquely identified in component identification column 406 as “Ambulance code” had a Label edited to “Ambulance squad code” in the new custom tree, shown in column 404, relative to the node in the baseline tree of “AmbulanceSquadCombo.” In embodiments, the node that is automatically selected as conflict free from the custom tree or the new tree is visually indicated as selected in either column 402 or column 404. As shown in FIG. 7A, “Ambulance squad code” has been selected and visually designated with a darkened outline in column 404 to indicate that node selection over the corresponding node in the custom tree. Notably, for the first node 504 “ReminderToSign” for which a conflict is identified, neither column 402 nor the column 404 indicates any selection by the hierarchy editor tool.

Details of each node in the custom tree and the new tree, including details of the structures and parameter values extracted from the underlying source code, are presented in column 402 for the custom tree and column 404 for the new tree. As shown in FIG. 7A, the GUI 400 provides columns and rows. For each conflict identified and annotated in the intermediate tree, column 402 includes one selectable option for a nested node of the custom tree and column 404 includes another selectable option for a corresponding nesting node in the new tree. As such, a user interacting with the hierarchy editor tool via the GUI 400, for example, may select one of these options to designate a desired option for the node in that particular row in the GUI 400. For example, the selection tool 420 may be manipulated and moved around areas of the GUI 400 in order to make a selection from one of columns 402 and 404, regarding the first node 504 “ReminderToSign.” As shown, column 402 presents specific values for structures and/or parameters values, as identified in the custom tree. Column 404 presents specific values for structures and/or parameters values, as identified in the new tree. Each of these specific values is a selectable option.

Additionally, although the hierarchy editor tool makes automatic selections for conflict free nodes, the selection tool 420 may yet be used to override these automatic selections. The selection tool 420 may select different options, at which time the intermediate tree 502 is dynamically updated in the preview pane 500 to reflect the option selected. In this way, a viewer may interact with the hierarchy editor tool to toggle back-and-forth between different selectable options from column 402 and column 404 in GUI 400 for the same node and immediately see the result or impact on the node(s) in the intermediate tree 502 of the preview pane 500. For example, a selection tool 420 may be used to hover over a desired option 706 as shown in FIG. 7B and/or to select the desired option 706 as shown in FIG. 7C. This selection overrides any automatic selection previously made by the hierarchy editor tool, those automatic selections being shown in FIG. 7A. In further aspects, the selection tool 420 may further be used to hover over and/or select the desired option 710 for a node so that the HTML or Script 712 changes for a node are presented, as shown in FIG. 7D.

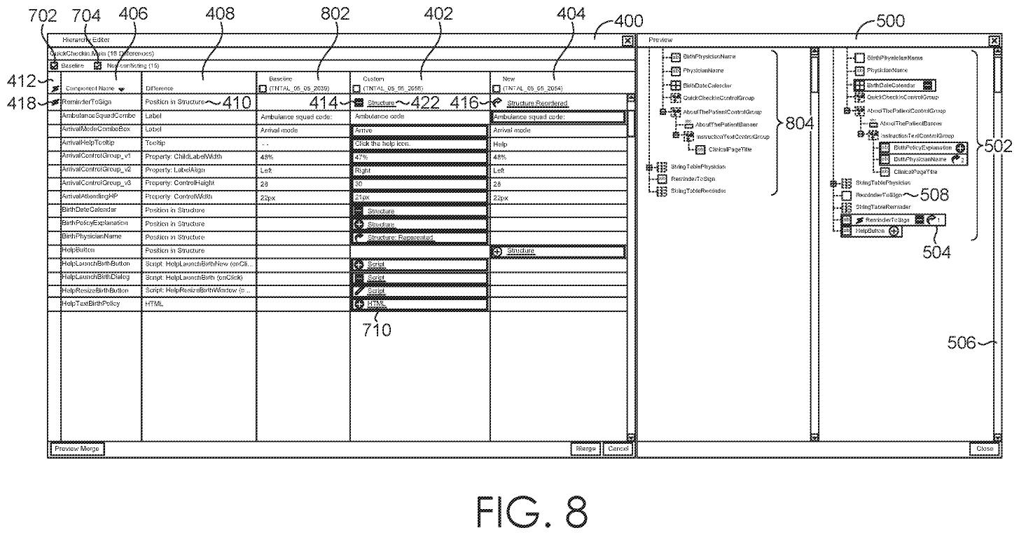

In FIG. 8, in response to a selection of the box 702 “Baseline,” the GUI 400 displays column 802. Column 802 presents structures and parameter values for the nodes of the baseline tree, in a manner similar to columns 402 and 404 with regard to their respective trees. Additionally, in response to a selection of any linking text present in column 802, the preview pane 500 is populated with the baseline tree 804. A viewer is able to “jump” to a specific node within the baseline tree 804, for example. In the preview pane 500, the baseline tree 804 is presented side-by-side with the intermediate tree 502, allowing a visual comparison of the nodes in each tree.

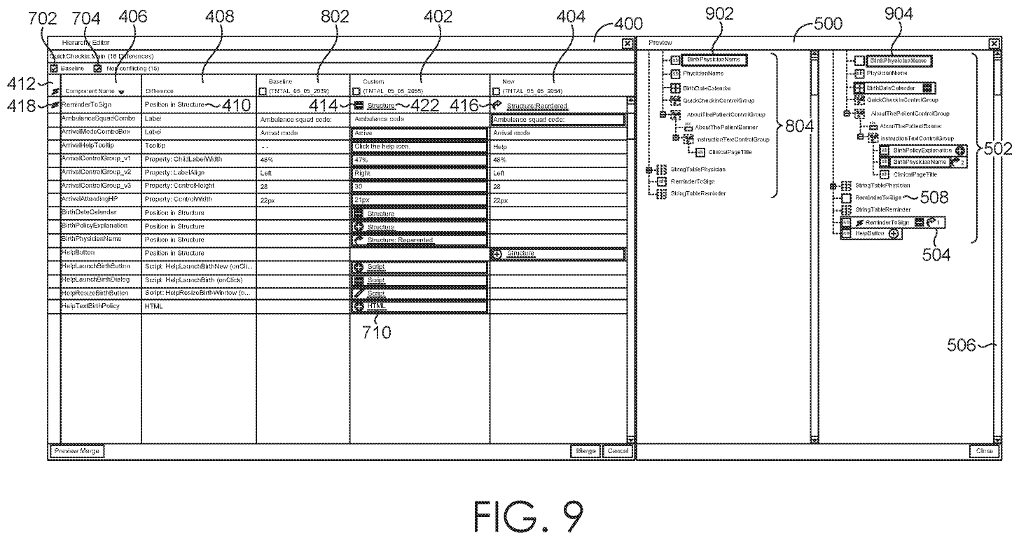

In the exemplary GUI of FIG. 9, further interaction with the hierarchy editor tool and the preview pane 500 are illustrated. Using the selection tool 420, a second node 902 “BirthPhysicianName” may be chosen from the baseline tree 804 in the preview pane 500, for example. In response, a corresponding node 904 “BirthPhysicianName” will be automatically visually accentuated in the intermediate tree 502 in the preview pane 500, to indicate a presence, absence, or new location of the corresponding node 904. In exemplary FIG. 9, the corresponding node 904 “BirthPhysicianName” is lowlighted in the intermediate tree 502, which indicates that the location of the corresponding node 904 changed relative to the baseline tree 804.

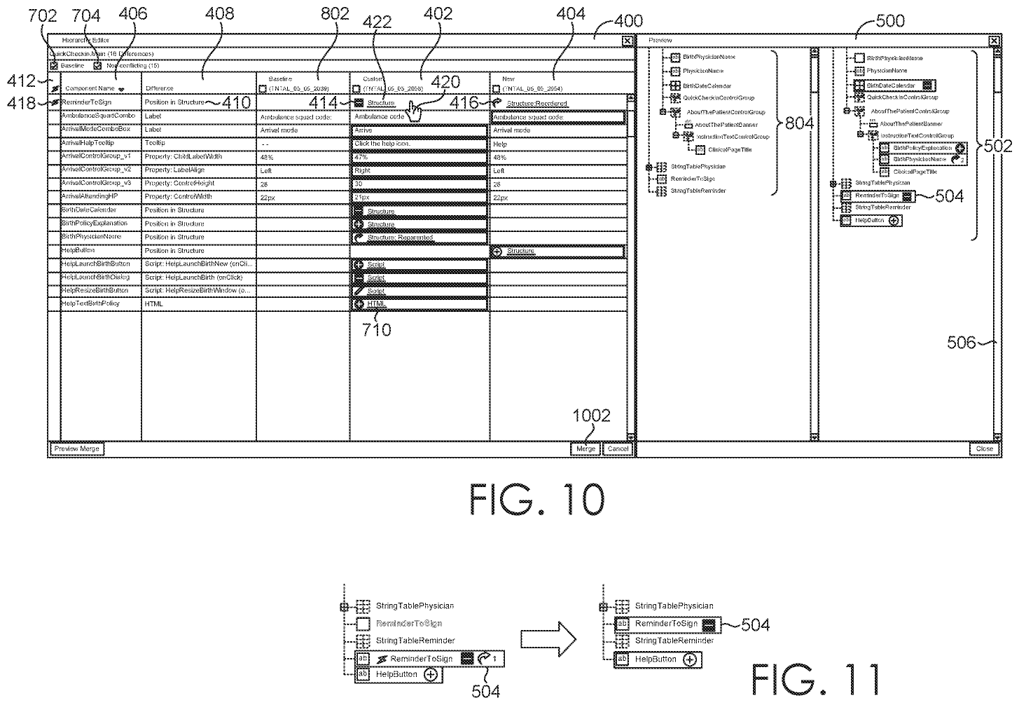

As discussed above, the GUI 400 presents a table with selectable options for various nodes of the custom tree in column 402 and selectable options for various nodes of the new tree in column 404. The GUI 400 also presents the preview pane 500 with the intermediate tree 502 and the baseline tree 804, based on selections of linking text in the GUI 400, for example. Both the table and the intermediate tree 502 are annotated with icons. In this example, the hierarchy editor tool has determined that one node has a conflict and many nodes are conflict-free, as shown in the first row of the table in GUI 400. FIG. 10 depicts an exemplary GUI in accordance with embodiments of the present invention, wherein the one node having a conflict may be resolved. The hierarchy editor tool may receive an indication, via the selection tool 420, that one of the selectable options for the first node 504 “ReminderToSign” in the custom tree or the new tree is selected. In this example, the indication identifies that the selectable option of the custom tree in column 402 is being chosen for resolving the conflict for the first node 504 “ReminderToSign.” The hierarchy editor tool dynamically updates the intermediate tree 502 in the preview pane 500 to reflect the selection of one of the selectable options for the first node 504 “ReminderToSign.” As shown in exemplary FIG. 11, the icon annotating the conflict of the first node 504 “ReminderToSign” and the icon that corresponds to unselected options in the table for the first node 504 “ReminderToSign” are removed from the intermediate tree 502. The annotating icon that represented the selected option from column 402 is retained and displayed in the intermediate tree 502. Accordingly, the selection tool 420, may be utilized to resolve any and all remaining conflicted nodes determined by the hierarchy editor tool.

Once all conflicts are resolved, a finalization GUI button 1002 is activated and becomes selectable in the GUI 400. In response to an indication to finalize the intermediate tree received via the selection tool 420, for example, the hierarchy editor tool finalizes the intermediate tree and its nodes based on the selected options in the GUI 400. The hierarchy editor tool encodes the nodes of the intermediate tree into new source code for a finalized user interface. The finalized intermediate tree is being written in a computer programming language by the hierarchy editor tool to represent the finalized intermediate tree, which at a high level is a merger of the nodes of the custom tree and the new tree.

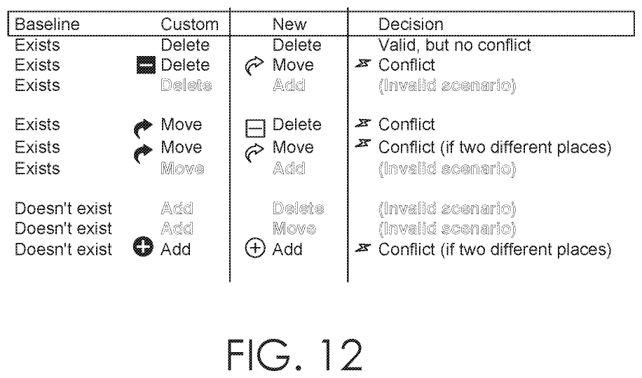

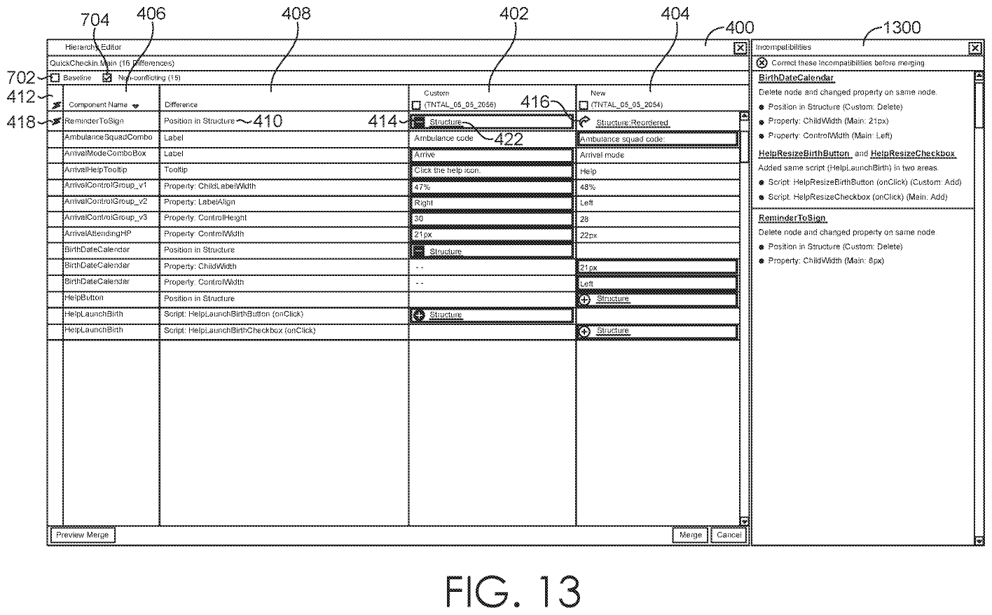

Prior to or concurrent with finalization, of the conflict-free intermediate tree, the hierarchy editor tool performs a validation logic against the intermediate tree to identify errors. For example, as presented in exemplary FIG. 12 invalid scenarios may arise in the intermediate tree that is to be or is being finalized. Invalid scenarios would produce errors in the finalized user interface. When a validation check is performed, the hierarchy editor tool determines whether any of the automatically selected options for nodes are incompatible with one another. As explained above, errors may be identified for automatically-selected nodes and for user-selected nodes. The hierarchy editor tool generates an error when automatically selected nested nodes are incompatible with one another. Then, the hierarchy editor tool provides a description of each error for display via the exemplary GUI of FIG. 13, for example, when it is determined that automatically selected nested nodes are incompatible with one another.

At FIG. 13, incompatibilities, invalid scenarios, and/or errors identified by the validation logic are displayed in a side pane 1300, with a detailed description of the errors. The side pane 1300 may present the unique identifier of each node, nested node (i.e., parameter values), and the like for which an error was identified. The side pane 1300 may describe the reason the error was identified in detail (e.g., “Added same script . . . in two areas,” “Delete node and changed property on same node”) such that a viewer can view the GUI 400 and immediately find the node(s) that should be modified to cure the error. The side pane 1300 is presented concurrently with the GUI 400, in embodiments. This allows a viewer to interact with the selectable options in the table of the GUI 400 while concurrently having access to the detailed error and node information displayed in the side pane 1300. Once options have been selected that correct the incompatibilities, invalid scenarios, and/or errors produced by the validation logic, the intermediate tree may be finalized.

It will be understood from this enabling description that the present invention is further applicable to any source code and/or source code for other objects and applications (i.e., other than user interfaces). As such, the present invention herein is not limited to user interfaces alone and source code of other types and for other object and applications are contemplated and considered to be within the scope of this disclosure.

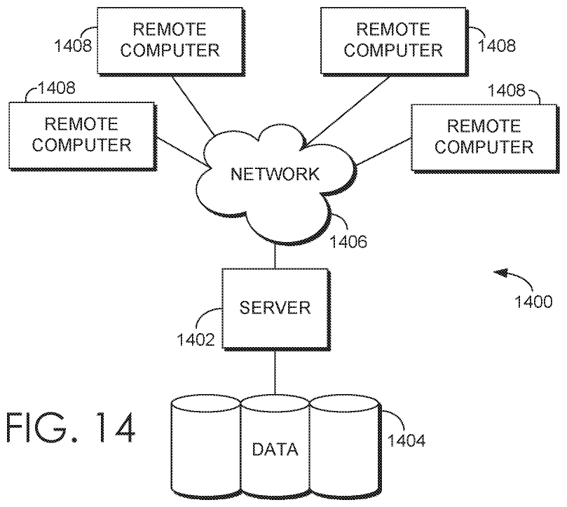

FIG. 14 depicts a block diagram of an exemplary environment suitable to implement embodiments of the present invention. The exemplary computing environment 1400 is suitable to implement embodiments of the present invention. It will be understood by those of ordinary skill in the art that the exemplary computing environment 1400 is just one example of a suitable computing environment and is not intended to limit the scope of use or functionality of the present invention. Similarly, the exemplary computing environment 1400 should not be interpreted as imputing any dependency and/or any requirements with regard to each component and combination(s) of components illustrated in FIG. 14. It will be appreciated by those having ordinary skill in the art that the connections illustrated in FIG. 14 are also exemplary as other methods, hardware, software, and devices for establishing a communications link between the components, devices, systems, and entities, as shown in FIG. 14, may be utilized in implementation of the present invention. Although the connections are depicted using one or more solid lines, it will be understood by those having ordinary skill in the art that the exemplary connections of FIG. 14 may be hardwired or wireless, and may use intermediary components that have been omitted or not included in FIG. 14 for simplicity's sake. As such, the absence of components from FIG. 14 should be not be interpreted as limiting the present invention to exclude additional components and combination(s) of components. Moreover, though devices and components are represented in FIG. 14 as singular devices and components, it will be appreciated that some embodiments may include a plurality of the devices and components such that FIG. 14 should not be considered as limiting the number of a device or component.

Continuing, the exemplary computing environment 1400 of FIG. 14 is illustrated as being a distributed environment where components and devices may be remote from one another and may perform separate tasks. The components and devices may communicate with one another and may be linked to each other using a network 1406. The network 1406 may include wireless and/or physical (e.g., hardwired) connections. Exemplary networks include a telecommunications network of a service provider or carrier, Wide Area Network (WAN), a Local Area Network (LAN), a Wireless Local Area Network (WLAN), a cellular telecommunications network, a Wi-Fi network, a short range wireless network, a Wireless Metropolitan Area Network (WMAN), a Bluetooth® capable network, a fiber optic network, or a combination thereof. The network 1406, generally, provides the components and devices access to the Internet and web-based applications.

The exemplary computing environment 1400 comprises a computing device in the form of a server 1402. Although illustrated as one component in FIG. 14, the present invention may utilize a plurality of local servers and/or remote servers in the exemplary computing environment 1400. The server 1402 may include components such as a processing unit, internal system memory, and a suitable system bus for coupling to various components, including a database or database cluster. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 1402 may include or may have access to computer-readable media. Computer-readable media can be any available media that may be accessed by server 1402, and includes volatile and nonvolatile media, as well as removable and non-removable media. By way of example, and not limitation, computer-readable media may include computer storage media and communication media. Computer storage media may include, without limitation, volatile and nonvolatile media, as well as removable and non-removable media, implemented in any method or technology for storage of information, such as computer-readable instructions, data structures, program modules, or other data. In this regard, computer storage media may include, but is not limited to, Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 1402. Computer storage media does not comprise signals per se.

Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

In embodiments, the server 1402 uses logical connections to communicate with one or more remote computers 1408 within the exemplary computing environment 1400. In embodiments where the network 1406 includes a wireless network, the server 1402 may employ a modem to establish communications with the Internet, the server 1402 may connect to the Internet using Wi-Fi or wireless access points, or the server 1402 may use a wireless network adapter to access the Internet. The server 1402 engages in two-way communication with any or all of the components and devices illustrated in FIG. 14, using the network 1406. Accordingly, the server 1402 may send data to and receive data from the remote computers 1408 over the network 1406.

Although illustrated as a single device, the remote computers 1408 may include multiple computing devices. In an embodiment having a distributed network, the remote computers 1408 may be located at one or more different geographic locations. In an embodiment where the remote computers 1408 is a plurality of computing devices, each of the plurality of computing devices may be located across various locations such as buildings in a campus, medical and research facilities at a medical complex, offices or “branches” of a banking/credit entity, or may be mobile devices that are wearable or carried by personnel, or attached to vehicles or trackable items in a warehouse, for example.

In some embodiments, the remote computers 1408 are physically located in a medical setting such as, for example, a laboratory, inpatient room, an outpatient room, a hospital, a medical vehicle, a veterinary environment, an ambulatory setting, a medical billing office, a financial or administrative office, hospital administration setting, an in-home medical care environment, and/or medical professionals' offices. By way of example, a medical professional may include physicians; medical specialists such as surgeons, radiologists, cardiologists, and oncologists; emergency medical technicians; physicians' assistants; nurse practitioners; nurses; nurses' aides; pharmacists; dieticians; microbiologists; laboratory experts; genetic counselors; researchers; veterinarians; students; and the like. In other embodiments, the remote computers 1406 may be physically located in a non-medical setting, such as a packing and shipping facility or deployed within a fleet of delivery or courier vehicles.

Continuing, the exemplary computing environment 1400 includes a data store 1404. Although shown as a single component, the data store 1404 may be implemented using multiple data stores that are communicatively coupled to one another, independent of the geographic or physical location of a memory device. Exemplary data stores may also store data in the form of electronic records, for example, electronic medical records of patients, transaction records, billing records, task and workflow records, chronological event records, and the like.

Generally, the data store 1404 includes physical memory that is configured to store information encoded in data. For example, the data store 1404 may provide storage for computer-readable instructions, computer-executable instructions, data structures, data arrays, computer programs, applications, and other data that supports the functions and action to be undertaken using the exemplary computing environment 1400 and components shown in exemplary FIG. 14.

In a computing environment having distributed components that are communicatively coupled via the network 1406, program modules may be located in local and/or remote computer storage media including, for example only, memory storage devices. Embodiments of the present invention may be described in the context of computer-executable instructions, such as program modules, being executed by a computing device. Program modules may include, but are not limited to, routines, programs, objects, components, and data structures that perform particular tasks or implement particular data types. In embodiments, the server 1402 may access, retrieve, communicate, receive, and update information stored in the data store 1404, including program modules. Accordingly, the server 1402 may execute, using a processor, computer instructions stored in the data store 1404 in order to perform embodiments described herein.

Although internal components of the devices in FIG. 14, such as the server 1402, are not illustrated, those of ordinary skill in the art will appreciate that internal components and their interconnection are present in the devices of FIG. 14. Accordingly, additional details concerning the internal construction of the device are not further disclosed herein.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. A computer-implemented method comprising:
obtaining code for each of a baseline user interface, a custom user interface, and a new user interface;
generating a baseline tree, a custom tree, and a new tree based on a plurality of unique identifiers located in the respective code of the baseline user interface, the custom user interface, and the new user interface, wherein each of the baseline tree, the custom tree, and the new tree include a hierarchy of nested nodes that represent respective structures of the baseline user interface, the custom user interface, or the new user interface;
generating an intermediate tree that is a combination of the custom tree and the new tree, wherein the intermediate tree includes a hierarchy of nested nodes that represent the structures of one or more of the custom user interface or the new user interface;
identifying a conflict at a node in the intermediate tree;
concurrently presenting a user-interactive visual representation of the baseline tree and the intermediate tree via a graphical user interface (GUI), wherein the node in the intermediate tree is annotated with a conflict resolution icon to represent the conflict identified for the node;
dynamically updating the intermediate tree in the GUI in response to a user interaction with the GUI designating a resolution to the conflict identified; and
in response to an indication to finalize the intermediate tree, encoding the hierarchy of nested nodes of the intermediate tree to create a finalized user interface that is a merger of the structures of the custom user interface and the new user interface.

2. The method of claim 1, further comprising:
determining whether each of the nested nodes in the baseline tree is present, absent, or at a different relative location within the custom tree; and
determining whether each of the nested nodes in the baseline tree is present, absent, or at a different relative location within the new tree.

3. The method of claim 1, further comprising:
when a nested node in the baseline tree is present in the custom tree, determining a structure of the baseline user interface corresponding to the nested node is conserved in the custom user interface;
when a nested node in the baseline tree is absent in the custom tree, determining a structure of the baseline user interface corresponding to the nested node is omitted from the custom user interface;
when a nested node present in the baseline hierarchy tree and the custom hierarchy tree has a different location in the baseline tree relative to custom tree, determining a structure of the baseline user interface is modified in the custom user interface; and
when a nested node in the custom tree is not present in the baseline tree, determining a structure corresponding to the nested node was added to the custom user interface.

4. The method of claim 1, further comprising:
when a nested node in the baseline tree is present in the new tree, determining a structure of the baseline user interface corresponding to the nested node is conserved in the new user interface;
when a nested node in the baseline tree is absent in the new tree, determining a structure of the baseline user interface corresponding to the nested node is omitted from the new user interface;
when a nested node present in the baseline tree and the new tree has a different location in the baseline tree relative to the new tree, determining a structure of the baseline user interface corresponding to the nested node is modified in the new user interface; and
when a nested node in the new tree is not present in the baseline tree, determining a structure corresponding to the nested node was added to the new user interface.

5. The method of claim 1, wherein a conflict is identified when one or more of presence, absence, or relative location of a nested node in the custom tree for a particular structure in the custom user interface and a corresponding nested node in the new tree for the particular structure in the new user interface are different from one or more of presence, absence, or relative location of a corresponding nested node in the baseline tree for the particular structure in the baseline user interface.

6. The method of claim 1, wherein a conflict is identified when a nested node in the custom tree for a parameter value of a particular structure in the custom user interface and a corresponding nested node in the new tree for the parameter value of the particular structure in the new user interface are different for one or more of presence, absence, or location from a corresponding nested node in the baseline tree for the parameter value of the particular structure in the baseline user interface.

7. The method of claim 1, further comprising:
concurrently presenting a table with the user-interactive visual representation of the baseline tree and the intermediate tree via the GUI, the table including, for the conflict identified and annotated in the intermediate tree, a selectable option for a nested node in the custom tree and a selectable option for a corresponding nesting node in the new tree.

8. The method of claim 7, further comprising:
receiving an indication of a user selection of one of the selectable option for the nested node in the custom tree or the selectable option for the corresponding nesting node in the new tree,
wherein the intermediate tree is dynamically updated in the GUI to reflect the user selection.

9. The method of claim 1, further comprising:
for each of the baseline user interface, the custom user interface, and the new user interface, locating a plurality of unique identifiers in the respective code that corresponds to structures of one or more of the baseline user interface, the custom user interface, and the new user interface;

10. The method of claim 1, wherein the intermediate tree cannot be finalized until no conflicts remain unresolved.

11. One or more non-transitory computer-readable media having executable instructions embodied thereon that, when executed by a processor of a computer device, perform a method, the method comprising:
obtaining code for each of a baseline user interface, a custom user interface, and a new user interface;
for each of the baseline user interface, the custom user interface, and the new user interface, locating a plurality of unique identifiers in the code that corresponds to structures of one or more of the baseline user interface, the custom user interface, and the new user interface;
generating a baseline tree that represents the baseline user interface based on the plurality of unique identifiers located in the code of the baseline user interface, wherein the baseline tree includes a hierarchy of nested nodes that represent structures of the baseline user interface;
generating a custom tree that represents the custom user interface based on the plurality of unique identifiers located in the code of the custom user interface, wherein the custom tree includes a hierarchy of nested nodes that represent structures of the custom user interface;
generating a new tree that represents the new user interface based on the plurality of unique identifiers located in the code of the new user interface, wherein the new tree includes a hierarchy of nested nodes that represent structures of the new user interface;
identifying differences between the nested nodes of the baseline tree and the nested nodes of the custom tree, and between the nested nodes of the baseline tree and the nested nodes of the new tree;
generating an intermediate tree from the custom tree and the new tree, wherein the intermediate tree includes a hierarchy of nested nodes that represents the structures of one or more of the custom user interface or the new user interface;
identifying a conflict at a nested node in the intermediate tree;
concurrently presenting a user-interactive visual representation of the baseline tree and the intermediate tree via a graphical user interface (GUI), wherein the nested node in the intermediate tree is annotated with a conflict resolution icon to represent the conflict identified for the nested node;
dynamically updating the intermediate tree in the GUI in response to a user-interaction with the GUI designating a resolution to the conflict identified; and
in response to an indication to finalize the intermediate tree, encoding the hierarchy of nested nodes of the intermediate tree to create a finalized user interface that is a combination of the structures of the custom user interface and the new user interface.

12. The media of claim 11, wherein identifying differences between the nested nodes of the baseline tree and the nested nodes of the custom tree, and the nested nodes of the baseline tree and the nested nodes of the new tree comprises:
determining whether each node in the baseline tree is present, absent, or at a different relative location within the custom tree; and
determining whether each node in the baseline tree is present, absent, or at a different relative location within the new tree.

13. The media of claim 11, wherein a conflict is identified when one or more of presence, absence, or relative location of the nested node in the custom tree and a corresponding nested node in the new tree are different from one or more of presence, absence, or relative location of a corresponding node in the baseline tree.

14. The media of claim 13, further comprising:
presenting the nested node in the intermediate tree for which the conflict is identified, a type icon specifying an addition, a deletion, a location change, or a script edit for the nested node in the custom tree, and a type icon specifying an addition, a deletion, a location change, or a script edit for the nested node in the new tree.

15. The media of claim 13, further comprising:
concurrently presenting a table in the user-interactive visual representation of the baseline tree and the intermediate tree via the GUI, wherein the table displays a conflict icon for the conflict identified, the table further including a selectable option for a nested node in the custom tree and a selectable option for a corresponding nesting node in the new tree, wherein selection of one of the selectable options resolves the conflict identified for the node.

16. One or more non-transitory computer-readable media having executable instructions embodied thereon that, when executed by a processor of a computer device, perform a method, the method comprising:
obtaining code for each of a baseline user interface, a custom user interface, and a new user interface;
for each of the baseline user interface, the custom user interface, and the new user interface, locating a plurality of unique identifiers in each code that corresponds to structures of one or more of the baseline user interface, the custom user interface, and the new user interface;
generating a baseline tree, a custom tree, and a new tree based on the plurality of unique identifiers located in the respective code of the baseline user interface, the custom user interface, and the new user interface, each of the baseline tree, the custom tree, and the new tree including a hierarchy of nested nodes that represent structures of the respective baseline user interface, custom user interface, or new user interface;
generating an intermediate tree that is a combination of the custom tree and the new tree, wherein the intermediate tree includes a hierarchy of nested nodes that represents structures of one or more of the custom user interface or the new user interface;
identifying a conflict at a node in the intermediate tree;
concurrently presenting a user-interactive visual representation of the baseline tree and the intermediate tree via a graphical user interface (GUI), wherein the node in the intermediate tree is annotated with a conflict resolution icon to represent the conflict identified for the node;
dynamically updating the intermediate tree in the GUI in response to a user interaction with the GUI designating a resolution to the conflict;
in response to an indication to finalize the intermediate tree, performing a validation logic against the intermediate tree to identify any errors; and
encoding the hierarchy of nested nodes of the intermediate tree to create a finalized user interface that is a merger of the structures of one or more of the custom user interface and the new user interface when the validation logic successfully runs without identifying any errors.

17. The media of claim 16, further comprising:
automatically selecting a nested node in the custom tree for inclusion in the intermediate tree when the nested node in the custom tree is different from a corresponding node in the baseline tree and a corresponding nested node in the new tree is the same as the corresponding node in the baseline tree; and
automatically selecting a nested node in the new tree for inclusion in the intermediate tree when the nested node in the new tree is different from a corresponding node in the baseline tree and a corresponding nested node in the custom tree is the same as the corresponding node in the baseline tree.

18. The media of claim 16, wherein performing the validation logic against the intermediate tree to identify any errors comprises:
determining whether automatically selected nested nodes are incompatible with one another;
generating an error when automatically selected nested nodes are incompatible with one another; and
providing a description of each error for display via the GUI when it is determined that automatically selected nested nodes are incompatible with one another.

19. The media of claim 17, wherein automatically selected nodes are incompatible with one another when an action to one node selected from the custom tree cannot be performed with another action to a node selected from the new tree.

20. The media of claim 16, further comprising:
when an error is identified, providing a detailed description of the error and the node associated with the error for display via the GUI; and
providing one or more selectable options from the custom tree or the new tree for display via the GUI to cure the error.
